(19) United States
(12) Patent Application Publication
(10) Pub. No.: US 2011/0239009 A1
(43) Pub. Date: Sep. 29, 2011

(54) STORAGE DEVICE

(75) Inventor: Takahiro NODA, Nagoya (JP)

(73) Assignee: BUFFALO INC., Nagoya-shi (JP)

(21) Appl. No.: 13/071,379

(22) Filed: Mar. 24, 2011

(30) Foreign Application Priority Data
Mar. 26, 2010 (JP) 2010-72767

(51) Int. Cl. G06F 1/26

(52) U.S. Cl. 713/300

(57) ABSTRACT

The storage device comprises a storage unit configured to store data in a non-volatile manner; a first connector configured to be connectable with a first interface having a first power supply capacity and receive a supply of electric power for operating the storage device from the first interface; a second connector configured to be connectable with a second interface having a second power supply capacity and receive a supply of electric power for operating the storage device from the second interface; an identification unit configured to identify a type of an interface connected via the first connector or the second connector; and a control unit configured to control power consumption of the storage unit according to the identified type of the interface.

### CROSS-REFERENCE TO RELATED APPLICATION

The present application claims the priority based on Japanese Patent Application No. 2010-72767 filed on Mar. 26, 2010, the disclosure of which is hereby incorporated by reference in its entirety.

### BACKGROUND

1. Technical Field

The present invention relates to a storage device for non-volatile storage of data transferred from, for example, a computer.

2. Related Art

Memory cards with internal flash memories have been used in various applications as storage devices connected to a computer (see, for example, JP 2008-33379). A storage device with high-capacity flash memories called an SSD (solid state drive) has recently been used often, in place of a conventional hard disk drive. The SSD is generally connected to the computer by means of an interface, for example, USB (Universal Serial Bus), SATA (Serial ATA), or PATA (Parallel ATA). Some of SSDs are equipped with multiple different types of interfaces.

Among these different types of interfaces, the USB (USB 2.0) is capable of supplying an electric current of up to 500 mA to peripheral equipment, such as the SSD, via a USB cable (up to 900 mA for USB 3.0). The SATA and the PATA have no such limitation of power supply.

Since the interfaces used for connecting the SSD with the computer have different power supply capacities, the power consumption of the SSD having multiple different types of interfaces should be designed to meet the requirement of an interface having the lowest power supply capacity. For reduction of the power consumption, flash memories and controllers having the high performance specifications are forced to operate at the lower speed. This issue is not characteristic of the SSD but is commonly found in devices connectable with multiple different interfaces having different power supply capacities.

### SUMMARY

By taking into account the issue discussed above, an object of the present invention is to provide a technique of operating a storage device according to the power supply capacity of a connected interface.

According to an aspect of the invention there is provided a storage device comprising one or more storage units configured to store data in a non-volatile manner; a first connector configured to be connectable with a first interface having a first power supply capacity and receive a supply of electric power for operating the storage device from the first interface; a second connector configured to be connectable with a second interface having a second power supply capacity and receive a supply of electric power for operating the storage device from the second interface; an identification unit configured to identify a type of an interface connected via the first connector or the second connector; and a control unit configured to control power consumption of the one or more storage units according to the identified type of the interface.

The storage device according to this aspect of the invention identifies the type of the interface connected via the first connector or the second connector and controls the power consumption of the storage according to the identified type of the interface. This feature enables the storage device to operate according to the power supply capacity of the connected interface. The first connector and the second connector may be physically separated from each other. Alternatively the first connector and the second connector may be physically integrated to allow for connection of both the first interface and the second interface.

In a preferable aspect, the storage device includes a plurality of the storage units, the control unit simultaneously accesses at least two storage units among the multiple storages to read or write data from or into the at least two storage units, and the control unit changes a number of simultaneous accesses to the multiple storages according to the identified type of the interface, so as to control the power consumption.

The storage device of this aspect varies the number of simultaneous accesses to the plurality of the storage units, so as to control the power consumption. The term ‘simultaneous accesses’ is not limited to accesses at a perfectly identical timing but also includes accesses at consecutive timings to enable data to be read from or written into the plurality of the storage units in parallel.

In a preferable aspect, the first power supply capacity is higher than the second power supply capacity, and when the identified type of the interface is the first interface, the control unit increases the number of simultaneous accesses to be greater than a number of simultaneous accesses in connection with the second interface.

The storage device of this aspect increases the number of simultaneous accesses to the plurality of the storage units for the interface having the higher power supply capacity. This feature enhances the data reading speed or the data writing speed.

In a preferable aspect, the control unit distributes the data and writes the distributed data in a specified sequence into each of the plurality of storage units, and the control unit writes the distributed data into each of the plurality of the storage units with keeping the specified sequence irrespective of a result of the identification of the type of the interface.

In the storage device of this aspect, the control unit reads or writes data from or into the plurality of the storage units in an identical sequence, whether the connected interface is the first interface or the second interface. In the state that some data have already been distributed and written into the plurality of the storage units, even when the connected interface is changed, this feature enables data to be normally written into or read from the plurality of the storage units without requiring any special processing, such as special address conversion.

In a preferable aspect, the control unit causes a non-working storage unit with no data currently written into or read from to be standby.

The storage device of this aspect causes a non-working storage with no data currently written into or read from to be standby. In connection with the interface having the less number of simultaneous accesses, this feature especially effectively reduces the power consumption.

In a preferable aspect, the identification unit detects a voltage of at least one power input terminal out of power input terminals of the first connector and of the second connector and identifies the type of the connected interface based on a result of the detection.

The storage device of this aspect detects a power voltage supplied to either the first connector or the second connector, so as to directly identify the type of the connected interface.

In a preferable aspect, the identification unit analyzes a protocol of a signal received from the interface connected via the first connector or the second connector and identifies the type of the connected interface based on a result of the analysis.

In a configuration where a power terminal is physically shared by the first connector and the second connector, the storage device of this aspect identifies the type of the connected interface, irrespective of the power voltage.

In a preferable aspect, the control unit restricts the number of simultaneous accesses to the multiple storages until completion of the identification by the identification unit.

In connection with the interface having the lower power supply capacity, the storage device of this aspect effectively prevents an increase of the power consumption during analysis of the protocol.

Besides the aspect of a storage device, the present invention in additional aspects thereof may be embodied as a control method of such a storage device and a computer program for controlling such a storage device. The computer program may be recorded in a computer readable recording medium. Any of various media including magnetic disks, optical disks, memory cards, and hard disks is applicable as the recording medium.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an illustration depicting the configuration of an SSD according to a first embodiment of the invention;

FIG. 2 is an illustration depicting the operations of simultaneously writing data into multiple flash memories by interleave control;

FIG. 3 is an illustration depicting one example of a management table;

FIG. 4 is an illustration depicting one sequence of accesses to the flash memories;

FIG. 5 is a flowchart showing an SSD start sequence;

FIGS. 6A and 6B are timing charts showing variations in operation states of the flash memories in different operation modes;

FIG. 7 is an illustration depicting another example of the management table;

FIG. 8 is an illustration depicting another sequence of accesses to the flash memories;

FIG. 9 is an illustration depicting the configuration of an SSD according to a second embodiment of the invention;

FIG. 10 is a flowchart showing an SSD start sequence executed in the second embodiment; and

FIG. 11 is an illustration depicting the configuration of an SSD according to a first modification.

### DESCRIPTION OF THE EMBODIMENTS

### A. First Embodiment

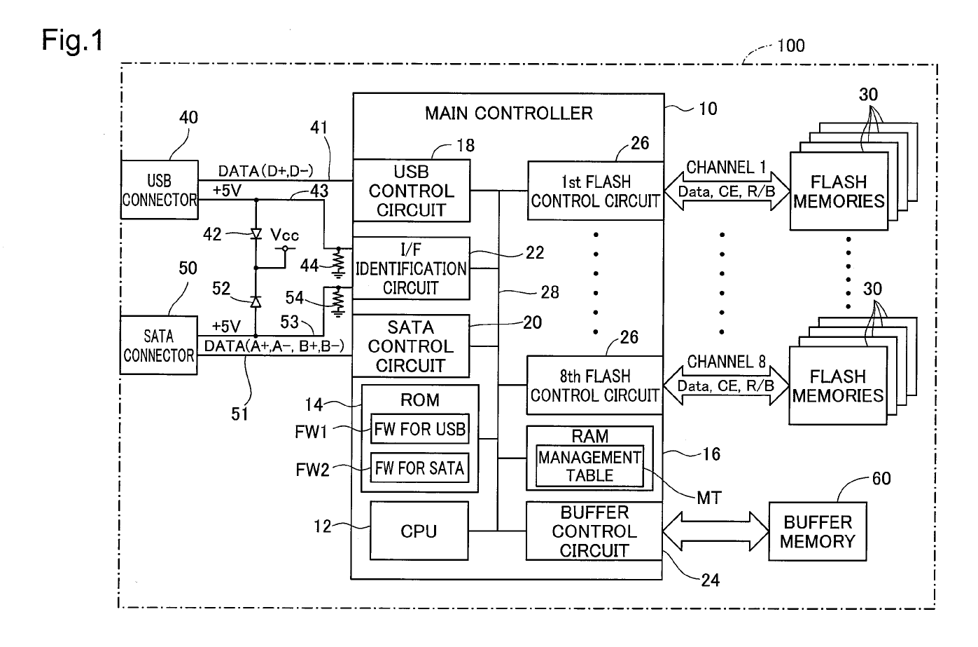

FIG. 1 is an illustration depicting the configuration of an SSD according to a first embodiment of the invention. The SSD 100 of this embodiment is configured as a secondary storage device used in connection with a host device (not shown), such as a personal computer. The SSD 100 includes a main controller 10, multiple flash memories 30, a USB connector 40, an SATA connector 50, and a buffer memory 60.

The main controller 10 includes a CPU 12, a ROM 14, a RAM 16, a USB control circuit 18, an SATA control circuit 20, an interface identification circuit 22, and a buffer control circuit 24, as well as eight flash control circuit 26 (1st to 8th flash control circuits). These components are interconnected via an internal bus 28.

The USB connector 40 is connected to the USB control circuit 18 via one set of data signal lines 41 (D+ and D−). The USB control circuit 18 controls data input and output in conformity with a USB 2.0 standard from and to a host device connected via the USB connector 40. The USB 2.0 standard enables data input and output from and to the host device at a communication speed of up to 480 Mbps. In this embodiment, the USB control circuit 18 establishes communication with the host device in conformity with the USB 2.0 standard. Alternatively the USB control circuit 18 may establish communication with the host device in conformity with any other suitable version of the USB standard.

The SATA connector 50 is connected to the SATA control circuit 20 via two sets of data signal lines 51 (A+ and A−, B+ and B−). The SATA control circuit 20 controls data input and output in conformity with a SATA2 standard from and to a host device connected via the SATA connector 50. The SATA2 standard enables data input and output from and to the host device at a communication speed of up to 3.0 Gbps. In this embodiment, the SATA control circuit 20 establishes communication with the host device in conformity with the SATA2 standard. Alternatively the SATA control circuit 20 may establish communication with the host device in conformity with any other suitable version of the SATA standard. In the specification hereof, the SATA standard includes an eSATA standard.

The USB connector 40 and the SATA connector 50 respectively have a power input terminal for receiving power supply from the host device. The USB connector 40 receives supply of electric power having a voltage level of 5 V and a maximum current of 500 mA, while the SATA connector 50 receives supply of electric power having a voltage level of 5 V (with no limitation of the amount of current). A power line 43 connecting with the power input terminal of the USB connector 40 and a power line 53 connecting with the power input terminal of the SATA connector 50 are respectively connected to a power line Vcc of the SSD 100 via Schottky barrier diodes 42 and 52 functioning to interfere with mutual invasion of electric current. Power input terminals of the main controller 10, the flash memories 30, and the buffer memory 60 are connected to the power line Vcc.

The interface identification circuit 22 functions to identify the type of a connection interface currently used for connecting the SSD 100 to the host device. The power line 43 connecting with the power input terminal of the USB connector 40 and the power line 53 connecting with the power input terminal of the SATA connector 50 are respectively connected to the interface identification circuit 22. Upon detection of a voltage input of or above a predetermined voltage level (for example, 3 V) via the USB power line 43, the interface identification circuit 22 identifies that a USB is the currently used connection interface for connecting the SSD 100 to the host device. Upon detection of a voltage input of or above the predetermined voltage level via the SATA power line 53, on the other hand, the interface identification circuit 22 identifies that an SATA is the currently used connection interface. The interface identification circuit 22 informs the CPU 12 of an identification signal representing a result of such identification. In order to prevent malfunction of the interface identification circuit 22 at the time of terminal disconnection, the respective power lines 43 and 53 are grounded via resistors 44 and 54.

Each of the eight flash control circuits 26 has connection with four NAND flash memories 30 by means of a data bus line, chip enable signal lines, and ready/busy signal lines. The data bus line is a common bus shared by the four flash memories 30. A set of each flash control circuit 26 and multiple flash memories 30 connected thereto via a common data bus line is called a ‘channel’. The flash control circuit 26 outputs a chip enable signal CE to one of the flash memories 30 via a corresponding chip enable signal line so as to select the flash memory 30 receiving the chip enable signal as an object to be accessed. The flash control circuit 26 receives a ready/busy signal R/B from each of the connected flash memories 30 via a corresponding ready/busy signal line so as to detect the operation status of the flash memory 30 and control actual data writing into or data reading from the flash memory 30. Each of the flash control circuits 26 of this embodiment is capable of performing interleave control of writing data in parallel to the four flash memories 30 connected thereto. The main controller 10 of the embodiment is thus capable of performing interleave control for the four flash memories 30 in each of the eight channels and thus enables simultaneous operations of up to the thirty two flash memories 30 in parallel.

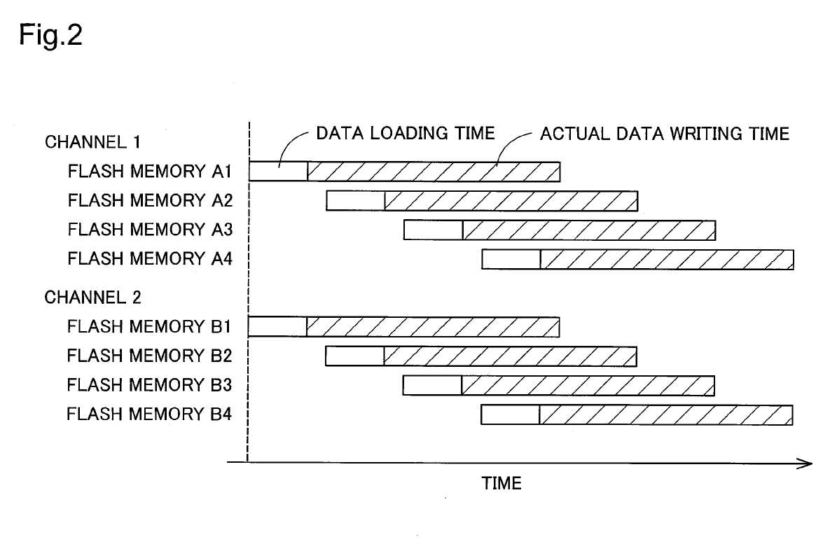

FIG. 2 is an illustration depicting the operations of simultaneously writing data into the multiple flash memories 30 by such interleave control. In the illustrated example of FIG. 2, data are simultaneously written into a total of eight flash memories 30 (flash memories A1 to A4 and flash memories B1 to B4) in two separate channels (channel 1 and channel 2). The channel 1 and the channel 2 are individually driven by the independent flash control circuits 26 so as to have perfectly simultaneous operations as shown in FIG. 2. The four flash memories 30 included in one channel use one common data bus line, so that the flash control circuit 26 sequentially loads write data onto page register circuits included in the respective flash memories 30 with slight time shifts. When data is loaded onto the page register circuit in each of the flash memories 30, the flash memory 30 actually writes the data loaded on the page register circuit into a memory cell array. In general, a data loading time onto the flash memory 30 is shorter than an actual data writing time in the flash memory 30. The interleave control accordingly does not overlap the data loading time onto each of the flash memories 30 but overlaps the physical data writing time in each of the flash memories 30, thereby enabling simultaneous data writing into the multiple flash memories 30 in parallel.

The buffer control circuit 24 (FIG. 1) functions to control data reading from or data writing into the buffer memory 60 implemented as, for example, a DRAM. As is known in the art, data is written into or read from the flash memory 30 in units of pages, each page consisting of multiple bits (for example, 2112 bytes), while data is deleted in units of blocks, each block consisting of multiple pages (for example, 64 pages). Directly overwriting data in the flash memory 30 is not allowed, so that new data should be written into the flash memory 30 after deletion of the existing data. Upon a requirement for overwriting data in the flash memory 30, the CPU 12 temporarily reads out and saves data of a subject block including an object data writing area into the buffer memory 60 and deletes the subject block. The CPU 12 subsequently processes the temporarily saved data by a required data rewrite operation in the buffer memory 60 and writes back the processed data into the subject block.

The ROM 14 stores a firmware FW1 for USB and a firmware FW2 for SATA. On a start of the SSD 100, the CPU 12 selects one firmware to be loaded from the ROM 14 to the RAM 16, based on the connection interface identified by the interface identification circuit 22. More specifically, when the interface identification circuit 22 identifies the connection interface as the USB, the CPU 12 loads the firmware FW1 for USB from the ROM 14. When the interface identification circuit 22 identifies the connection interface as the SATA, on the other hand, the CPU 12 loads the firmware FW2 for SATA from the ROM 14. The CPU 12 controls communication with the host device via the USB control circuit 18 or the SATA control circuit 20 and data writing into or data reading from the flash memories 30 via the respective flash control circuits 26 according to the selected firmware loaded onto the RAM 16. The differences between the functions of the firmware FW1 for USB and the firmware FW2 for SATA will be described later in detail.

On the start of the SSD 100, a management table MT is read from a preset area in the flash memories 30 and is stored in the RAM 16. The management table MT is used for conversion between logical addresses open to the host device and physical addresses used in the flash memories 30. The CPU 12 refers to this management table MT to make conversion between the logical address and the physical address and causes the corresponding flash control circuit 26 to control data writing into or data reading from the respective flash memories 30 connected thereto.

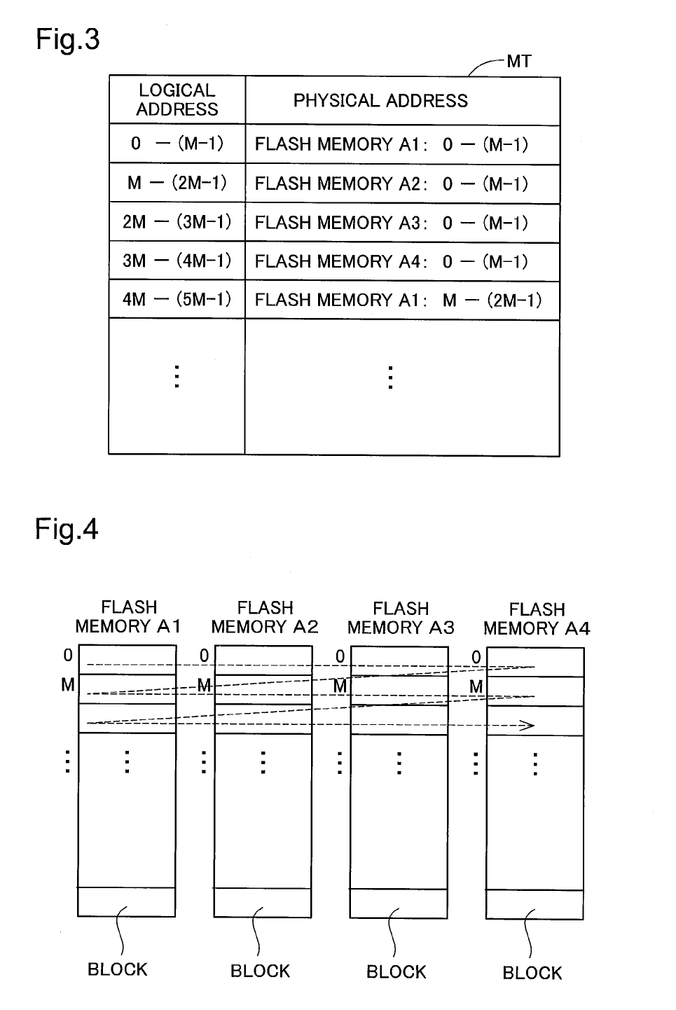

FIG. 3 is an illustration depicting one example of the management table MT. FIG. 4 is an illustration depicting a sequence of accesses to the flash memories specified by the management table MT. For the simplicity of explanation, the management table MT shown in FIG. 3 is to be referred to for accesses to the flash memories A1 to A4 in the channel 1. In the management table MT of FIG. 3, physical addresses are specified to sequentially allocate blocks in the four flash memories A1 to A4 to consecutive logical addresses. In the example of FIGS. 3 and 4, each block has a size of ‘M bytes’. By referring to this management table MT having the above configuration, data can be written in units of blocks sequentially into the four flash memories A1 to A4 as shown in FIG. 4. The application of the management table MT enables data to be written into the four flash memories 30 simultaneously in the interleave control-enabled state, while enabling data to be written into the four flash memories 30 successively by the sequential accesses in the interleave control-disabled state. Namely data can be written into the multiple flash memories 30 in an identical writing sequence, regardless of enabling or disabling the interleave control. The SSD 100 of the embodiment is constructed to be simultaneously accessible to eight channels. In an actual state, when receiving write data from the host device, the CPU 12 distributes the received data into eight channels, refers to management tables MT provided for the respective channels, and writes data into the respective flash memories in the respective channels.

The following describes a series of processing performed on the start of the SSD 100.

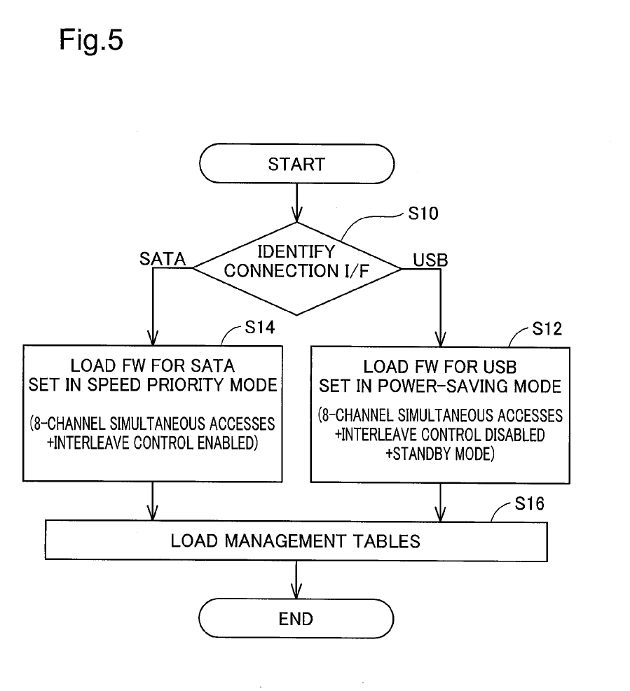

FIG. 5 is a flowchart showing a start sequence of the SSD. Connection of the SSD 100 to the host device by means of either a USB cable or an SATA cable causes electric power to be supplied from the host device to the SSD 100 via the cable. On a start of the SSD 100 with the power supply, the CPU 12 first identifies whether the connection interface with the host device is the USB or the SATA, based on the identification signal received from the interface identification circuit 22 (step S10).

Upon identification of the connection interface as the USB, the CPU 12 loads and executes the firmware FW1 for USB from the ROM 14 onto the RAM 16 (step S12). The CPU 12 sets an operation mode in a power-saving mode by execution of the firmware FW1 for USB. In the power-saving mode, the CPU 12 has simultaneous accesses to the flash memories in the eight channels, while prohibiting the respective flash control circuits 26 from performing the interleave control and actively setting the non-working flash memories 30 in a standby mode, thus reducing the power consumption.

Upon identification of the connection interface as the SATA, on the other hand, the CPU 12 loads and executes the firmware FW2 for SATA from the ROM 14 onto the RAM 16 (step S14). The CPU 12 sets the operation mode in a speed priority mode by execution of the firmware FW2 for SATA. In the speed priority mode, the CPU 12 has simultaneous accesses to the flash memories in the eight channels, while allowing the respective flash control circuits 26 to perform the interleave control and have simultaneous accesses to the thirty two flash memories, thus enhancing the data reading speed or the data writing speed.

After setting the operation mode according to the identification of the connection interface as described above, the CPU 12 loads the management table MT (FIG. 3) from the preset area in the flash memories 30 onto the RAM 16 (step S16). On completion of this series of start sequence, the CPU 12 controls data reading from or data writing into the flash memories 30 according to the operation mode set at either step S12 or step S14.

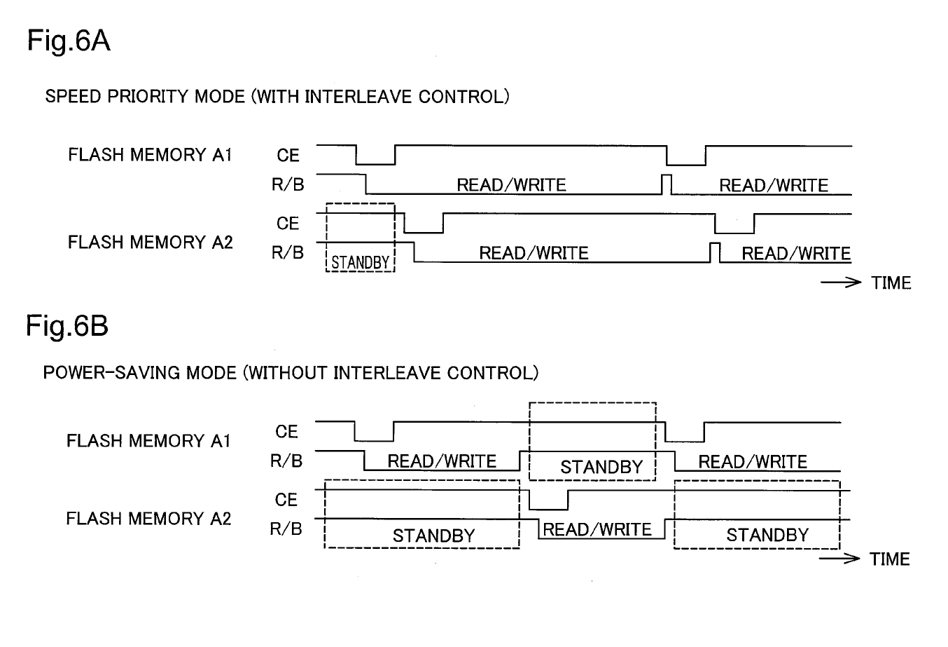

FIG. 6A is a timing chart showing the operation states of the flash memories in the speed priority mode. FIG. 6B is a timing chart showing the operation states of the flash memories in the power-saving mode. For the simplicity of explanation, the timing charts of FIGS. 6A and 6B are provided for the connection of only two flash memories A1 and A2 to one channel. In this embodiment, both the chip enable signal CE and the ready/busy signal R/B are at low levels in their active states. In the speed priority mode of FIG. 6A, in response to input of a pulse of the chip enable signal CE into the flash memory A1, the flash memory A1 becomes busy (Low) to perform data writing or data reading. On completion of data writing or data reading, the flash memory A1 becomes ready (High) to wait for another input of the chip enable signal CE. In response to another input of the chip enable signal CE, the flash memory A1 again becomes busy (Low). The interleave control is enabled in the speed priority mode. The chip enable signal CE is accordingly input into the flash memory A2 immediately after input into the flash memory A1. Namely the flash memory A2 becomes busy slightly after the flash memory A1 becomes busy. In general, in NAND flash memories, when both a chip enable signal and a busy signal are inactive (High), the operation state is set in a standby mode to reduce the power consumption. In the speed priority mode, however, flash memories other than the flash memory A1 included in one channel are set in the standby mode only at an initial timing prior to a start of data writing or data reading. After a start of data writing or data reading, the flash memories in the channel successively become busy. Until completion of data writing or data reading, the respective flash memories substantially continuously consume electric power. In the structure of FIG. 1 having the operation mode set in the speed priority mode, the thirty two flash memories for the eight channels at the maximum simultaneously consume the electric power.

The interleave control is disabled in the power-saving mode. In the power-saving mode of FIG. 6B, at the timing when the flash memory A1 is busy (Low), the flash memory A2 is ready (High). At the timing when the flash memory A1 is ready (High), the flash memory A2 is busy (Low). The flash memory A1 and the flash memory A2 are alternatively set in the standby mode. In the structure of FIG. 1 having the operation mode set in the power-saving mode, only one flash memory 30 in each channel is active at one time for data writing or data reading. Namely only the eight flash memories for the eight channels at the maximum simultaneously consume the electric power. The power-saving mode has a lower access speed than the access speed in the speed priority mode, but saves the total power consumption for all the flash memories to approximately one quarter of the power consumption in the speed priority mode.

As described above, the SSD 100 of the first embodiment automatically identifies the connection interface for connection between the host device and the SSD 100. Upon identification of the connection interface as the USB, the SSD 100 sets the operation mode in the power-saving mode with disabling the interleave control. Upon identification of the connection interface as the SATA, on the other hand, the SSD 100 sets the operation mode in the speed priority mode with enabling the interleave control. This arrangement enables the SSD 100 to operate in the optimum operation mode according to the identified connection interface. The SSD 100 of the embodiment is compatible with multiple different types of interfaces and accordingly has the enhanced compatibility for connection with various host devices.

The SSD 100 of the embodiment reduces the number of the simultaneously active flash memories 30 in the USB connection state to one quarter of the number in the SATA connection state. The respective flash memories 30 in each channel are frequently set in the standby mode as shown in FIG. 6B. This arrangement significantly reduces the power consumption and enables the SSD 100 to effectively operate with the power consumption of or below the maximum power supply amount (5V and 500 mA) for the USB. Such significant reduction of the power consumption prevents the loss of data or the failure in recognition of the SSD 100 by the host device due to the excessive power consumption.

The SSD 100 of the embodiment disables the interleave control in the USB connection state or in the power-saving mode but still allows for simultaneous accesses to the eight channels. The SSD 100 is thus operable at a speed meeting the maximum communication speed of 480 Mbps specified by the USB standard. The SSD 100 of the embodiment enables the interleave control in the SATA connection state or in the speed priority mode and allows for simultaneous activation of up to the thirty two flash memories 30 in parallel. The SSD 100 is thus operable at an extremely high speed meeting the maximum communication speed of 3.0 Gbps specified by the SATA standard. The SATA standard does not have any limitation of the maximum power consumption and thus allows the flash memories 30 and the main controller 10 to provide their performances irrespective of the power consumption.

The SSD 100 of the embodiment uses the identical management table MT (FIG. 3) for conversion between the logical address and the physical address both in the SATA connection state (speed priority mode) and in the USB connection state (power-saving mode). The data are accordingly written into the respective flash memories 30 in the sequence shown in FIG. 4, irrespective of the identified type of the connection interface. In the case of switching over the connection interface from the SATA to the USB or from the USB to the SATA, data can be normally written into or read from the respective flash memories 30 according to the common management table MT without requiring any special address conversion.

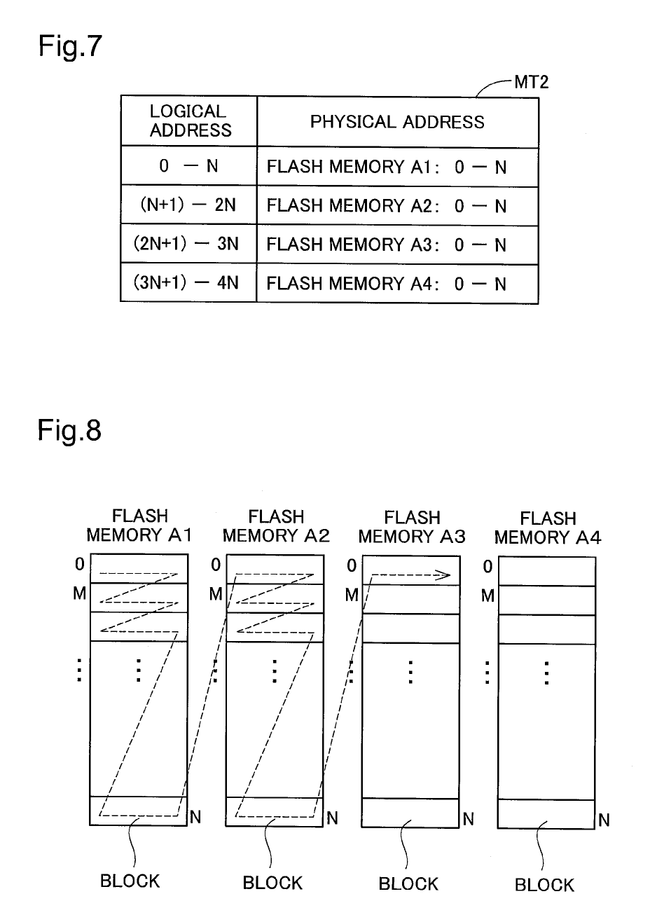

As described above, the SSD 100 of the embodiment uses the common management table MT both in the SATA connection state (speed priority mode) and in the USB connection state (power-saving mode) and thereby allows data to be written into or read from the respective flash memories 30 in the same sequence. Alternatively different management tables MT may be used in the SATA connection state and in the USB connection state. In this modification, the sequence of data writing or data reading in the SATA connection state is different from the sequence of data writing or data reading in the USB connection state. For example, in the SATA connection state, the management table MT shown in FIG. 3 may be used to write data in the sequence of FIG. 4. In the USB connection state, another management table MT2 shown in FIG. 7 may be used to start writing data into a next flash memory 30 after completion of data writing into all blocks of one flash memory 30 as shown in FIG. 8. Specifying this sequence of data writing in the USB connection state enables the other flash memories 30 to be kept in the standby mode while data is written into one flash memory 30. This modified arrangement thus efficiently reduces the power consumption.

### B. Second Embodiment

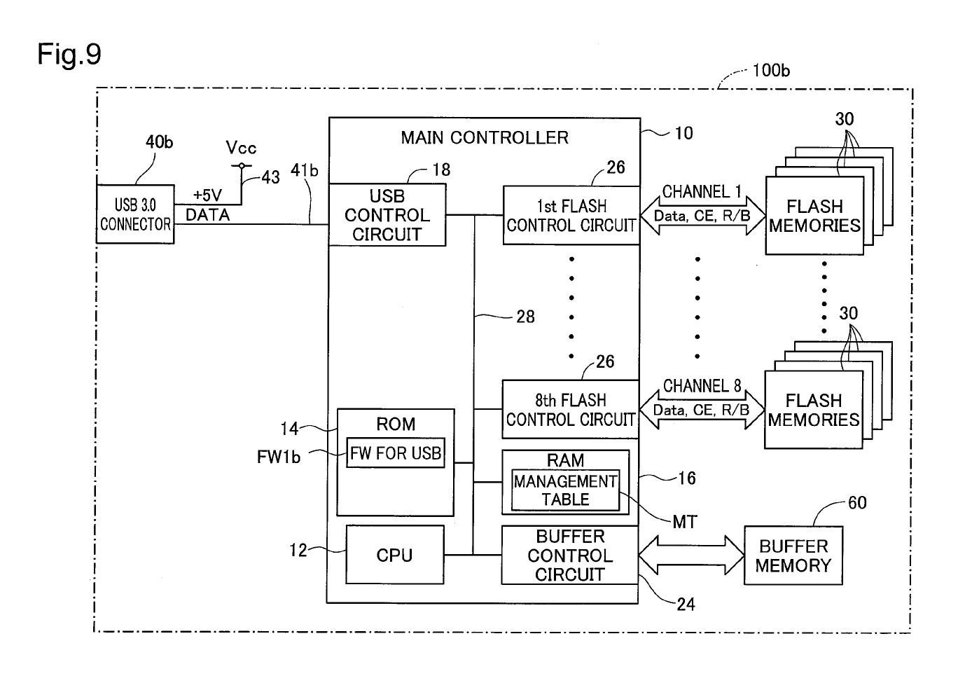

FIG. 9 is an illustration depicting the configuration of an SSD according to a second embodiment of the invention. The like components in the SSD 100b of the second embodiment shown in FIG. 9 to those in the SSD 100 of the first embodiment shown in FIG. 1 are expressed by the like numerals and symbols. The primary difference of the SSD 100b of the second embodiment shown in FIG. 9 from the SSD 100 of the first embodiment shown in FIG. 1 is omission of the SATA connector 50, the SATA control circuit 20, the interface identification circuit 22, and the firmware FW2 for SATA.

The SSD 100b of this embodiment has a USB connector 40b in conformity with a USB 3.0 standard. The USB 3.0 uses two sets of data signal lines 41b and enables data input and output from and to a host device at a communication speed of up to 5.0 Gbps. The USB 3.0 has power supply of up to 5V and 900 mA, which is almost twice the power supply amount in the USB 2.0 standard. The USB 3.0 adopts a different specification of data signal lines from that adopted by the USB 2.0 standard. The USB connector 40b in conformity with the USB 3.0 has the physical specification of backward compatibility and can thus receive connection with a USB cable in conformity with the USB 2.0. The USB 2.0 and the USB 3.0 have different specifications of data signal lines but an identical specification of power input terminals. It is accordingly impossible to identify whether the connection interface is compliant with the USB 2.0 or is compliant with the USB 3.0 based on the input of power supply as in the first embodiment. The SSD 100b of the second embodiment identifies the connection interface according to the following procedure.

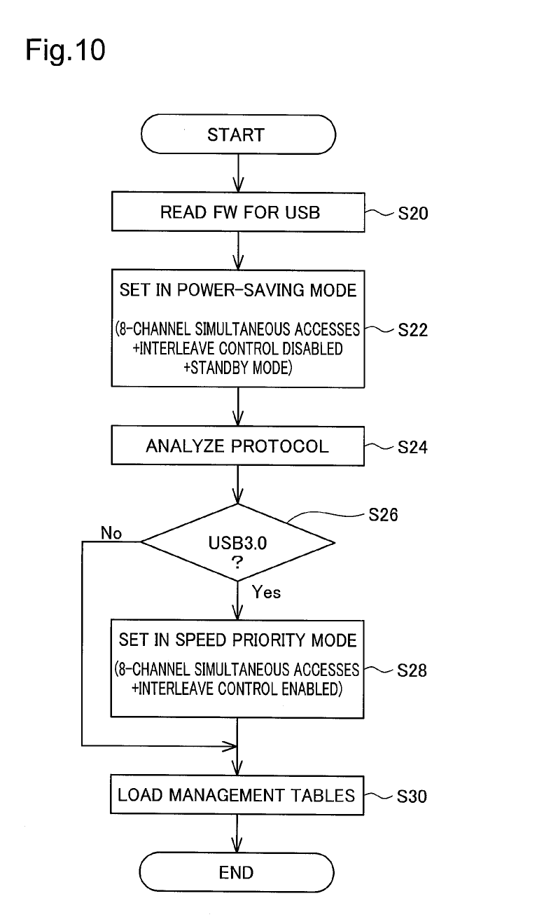

FIG. 10 is a flowchart showing a start sequence of the SSD 100b executed in the second embodiment. Connection of the SSD 100b to a host device by means of a USB cable causes electric power to be supplied from the host device to the SSD 100b via the cable. On a start of the SSD 100b with the power supply, the CPU 12 first loads a firmware FW1b for USB from the ROM 14 onto the RAM 16 (step S20). The CPU 12 sets an operation mode of the SSD 100b in the power-saving mode by execution of the firmware FW1b for USB (step S22).

The CPU 12 subsequently analyzes a protocol of USB commands transmitted between the host device and the SSD 100b (step S24) and identifies whether there is a connection in conformity with the USB 3.0 between the host device and the SSD 100b (step S26). Upon identification of the connection in conformity with the USB 3.0, the CPU 12 sets the operation mode of the SSB 100b in the speed priority mode (step S28). Upon identification of the connection not in conformity with the USB 3.0, on the other hand, the CPU 12 keeps the operation mode of the SSB 100b in the power-saving mode set at step S22.

After setting the operation mode according to the identification of the connection interface as described above, the CPU 12 loads the management table MT from a preset area in the flash memories 30 onto the RAM 16 (step S30). On completion of this series of start sequence, the CPU 12 controls data reading from or data writing into the flash memories 30 according to the operation mode set at either step S22 or step S28.

As described above, in the structure with interfaces of different power supply specifications connectable to one identical connector, the SSD 100b of the second embodiment analyzes the communication protocol and thereby accurately identifies the connection interface. The SATA connector 50, the SATA control circuit 20, and the interface identification circuit 22 are omitted from the SSD 100b of the second embodiment but may alternatively be mounted on the SSD 100b like the first embodiment. In this modified structure, the connection interface may be identified among the SATA, the USB 2.0, and the USB 3.0.

### C. Modifications

The embodiments and their applications of the invention are described above. The embodiments and their applications discussed above are to be considered in all aspects as illustrative and not restrictive. There may be many modifications, changes, and alterations without departing from the scope or spirit of the main characteristics of the present invention. For example, the functions of the software configuration may be actualized by the hardware configuration. Some other examples of possible modification are given below.

### Modification 1

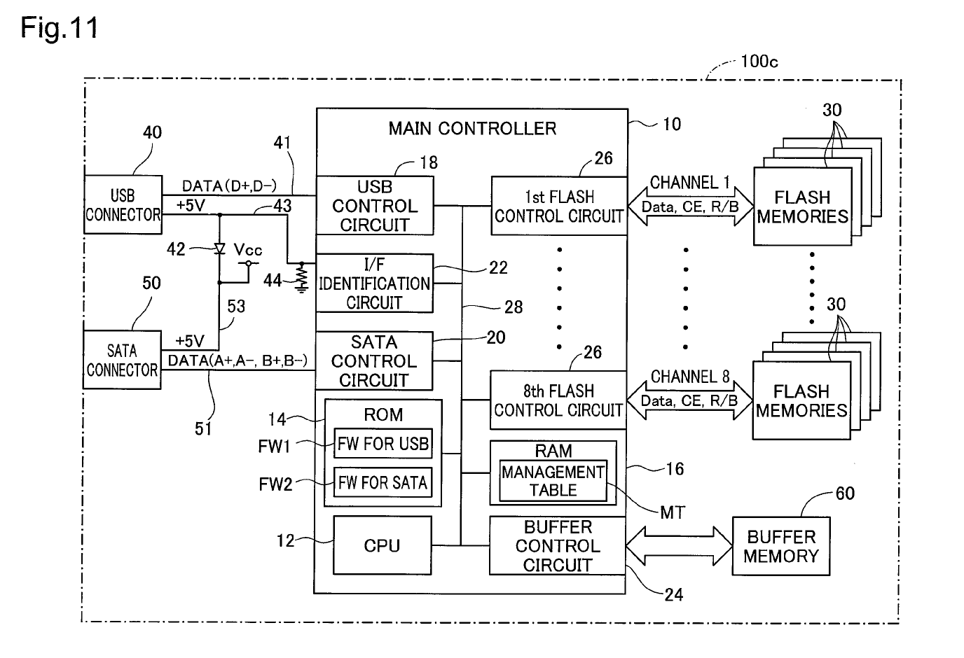

FIG. 11 is an illustration depicting the configuration of an SSD in a first modification. The SSD 100c of this modification has a different configuration of connection between the SATA connector 50 and the main controller 10 from the configuration in the SSD 100 of the first embodiment shown in FIG. 1. In the configuration of the first embodiment, both the power line 43 of the USB connector 40 and the power line 53 of the SATA connector 50 are connected to the interface identification circuit 22. In the configuration of this modification, only the power line 43 of the USB connector 40 is connected to the interface identification circuit 22. In this modified configuration, in the case of no power supply via the USB connector 40, the interface identification circuit 22 identifies the power supply via the SATA connector 50. The SSD 100c of this modification can thus identify the connection interface like the SSD 100 of the first embodiment. In a generalized configuration adopting the concept of this modification, when there are N different types of connection interfaces, connection of (N−1) power lines to the interface identification circuit 22 enables identification of the N different types of connection interfaces.

### Modification 2

In the embodiments described above, the operation state of the SSD is changed over according to the identification of the connection interface, for example, the USB or the SATA. The connection interface is, however, not restricted to the USB or the SATA. The invention may similarly applicable to any of other various connection interfaces that are capable of supplying electric power to the SSD or another storage device, for example, PATA, IEEE1394, PoE (Power over Ethernet)-compatible LAN interfaces.

### Modification 3

The above embodiments describe application of the present invention to the SSD. The technique of the invention is applicable to various storage devices using hard disks, optical disks, and magnetic disks as recording media. In these applications, the power consumption may be controlled according to the identification of the connection interface by varying the rotation number of a hard disk, an optical disk, or a magnetic disk. In a storage device including multiple recording media, the power consumption may be controlled according to the identification of the connection interface by varying the number of simultaneous accesses to the multiple recording media.

### Modification 4

In the embodiments described above, the number of simultaneously accessible channels is set to eight, and each channel has connection of four flash memories. The number of the channels and the number of flash memories are not restricted to these numbers. It is not essential to group each present number of multiple flash memories in a common bus (channel). All the flash memories 30 may be connected in parallel to the main controller 10.

### Modification 5

In the embodiments described above, the number of actually working flash memories 30 is changed by enabling or disabling the interleave control. The number of actually working flash memories 30 may be changed by varying the number of simultaneously accessible channels. This modified arrangement also enables the power consumption to be controlled according to the identification of the connection interface.

What is claimed is:

1. A storage device, comprising:
one or more storage units configured to store data in a non-volatile manner;
a first connector configured to be connectable with a first interface having a first power supply capacity and receive a supply of electric power for operating the storage device from the first interface;
a second connector configured to be connectable with a second interface having a second power supply capacity and receive a supply of electric power for operating the storage device from the second interface;
an identification unit configured to identify a type of an interface connected via the first connector or the second connector; and
a control unit configured to control power consumption of the one or more storage units according to the identified type of the interface.

2. The storage device according to claim 1, including a plurality of the storage units, wherein
the control unit simultaneously accesses at least two storage units among the plurality of the storage units to read or write data from or into the at least two storage units, and
the control unit changes a number of simultaneous accesses to the plurality of the storage units according to the identified type of the interface, so as to control the power consumption.

3. The storage device according to claim 2, wherein
the first power supply capacity is higher than the second power supply capacity, and
when the identified type of the interface is the first interface, the control unit increases the number of simultaneous accesses to be greater than a number of simultaneous accesses in connection with the second interface.

4. The storage device according to claim 2, wherein
the control unit distributes the data and writes the distributed data in a specified sequence into each of the plurality of the storage units, and
the control unit writes the distributed data into each of the plurality of the storage units with keeping the specified sequence irrespective of a result of the identification of the type of the interface.

5. The storage device according to claim 2, wherein
the control unit causes a non-working storage unit with no data currently written into or read from to be standby.

6. The storage device according to claim 1, wherein
the identification unit detects a voltage of at least one power input terminal out of power input terminals of the first connector and of the second connector and identifies the type of the connected interface based on a result of the detection.

7. The storage device according to claim 1, wherein
the identification unit analyzes a protocol of a signal received from the interface connected via the first connector or the second connector and identifies the type of the connected interface based on a result of the analysis.

8. The storage device according to claim 7, wherein
the control unit restricts the number of simultaneous accesses to the multiple storages until completion of the identification by the identification unit.
